(19) United States
(12) Patent Application Publication
(10) Pub. No.: US 2026/0339178 A1
(43) Pub. Date: Oct. 29, 2026

(54) Locking Assembly, Telescopic Leg and Photographic Tripod

(71) Applicant: ZhongShan Aoka Photographic Equipment Co., Ltd., Zhongshan City (CN)

(72) Inventor: Dacai Wang, Zhongshan City (CN)

(21) Appl. No.: 19/256,390

(22) Filed: Jul. 1, 2025

(30) Foreign Application Priority Data
Apr. 25, 2025 (CN) 2025208120999

(51) Int. Cl. G03B 17/56; F16M 11/32

(52) U.S. Cl. CPC G03B 17/561; F16M 11/32

(57) ABSTRACT

A locking assembly, a telescopic leg, and a photographic tripod are disclosed. The locking assembly includes a clamping ring having a locking channel, a cam lever, a linkage rod, and first to third pivot pins. A first pivot mount and a second pivot mount are disposed on opposite sides of the locking channel. One end of the cam lever is pivotally connected to the first pivot mount via the first pivot pin, and the linkage rod connects the cam lever to the second pivot mount via the second and third pivot pins. When the cam lever switches from the unlocked to the locked position, it drives the first and second pivot mounts to move toward each other, reducing the inner diameter of the clamping ring. This configuration ensures convenient operation, minimizes mechanical wear, and provides reliable and consistent locking performance for telescopic leg applications.

### FIELD OF INVENTION

The present invention relates to photographic equipment, and more particularly to a locking assembly, a telescopic leg incorporating the locking assembly, and a photographic tripod equipped with the telescopic leg.

### BACKGROUND OF THE INVENTION

With the rise in living standards, photography has become increasingly popular among consumers. To achieve higher-quality still or motion imaging, photographic tripods are frequently employed to support photographic or video equipment. These tripods typically include telescopic legs with multi-stage extension capabilities, enabling height adjustment as needed. The locking mechanisms for these telescopic legs are commonly operated using cam lever-based designs, which offer the advantages of mechanical simplicity and ease of operation.

Conventional locking assemblies generally operate based on the cam principle, wherein the cam undergoes stroke variation relative to its pivot point during rotation. This variation alters the inner diameter of a clamping ring, thereby achieving the locking or unlocking function. As the telescopic leg and cam components are often fabricated from metallic materials such as aluminum alloy, a gasket must be inserted at the cam interface to ensure proper locking performance. However, repeated locking and unlocking cycles cause the gasket to wear over time, diminishing the locking force and ultimately compromising the ability of the telescopic leg to remain extended. Accordingly, there is a critical need for an improved locking assembly, a telescopic leg employing the structure, and a photographic tripod capable of addressing these deficiencies.

### SUMMARY OF THE INVENTION

The present invention is directed to addressing at least one of the technical limitations found in the prior art. To this end, the invention provides an improved locking assembly, a telescopic leg incorporating the locking assembly, and a photographic tripod configured with such telescopic legs.

According to one embodiment, the locking assembly comprises a clamping ring, a cam lever, a linkage rod, a first pivot pin, a second pivot pin, and a third pivot pin. The clamping ring is provided with a locking channel, with a first pivot mount disposed on one side of the channel and a second pivot mount disposed on the opposite side. One end of the cam lever is pivotally connected to the first pivot mount via the first pivot pin, and the cam lever is switchable between an unlocked position and a locked position. One end of the linkage rod is pivotally connected to the cam lever via the second pivot pin, and the opposite end of the linkage rod is pivotally connected to the second pivot mount via the third pivot pin. When the cam lever is switched from the unlocked position to the locked position, it drives the first pivot mount and the second pivot mount to move toward each other through the linkage rod, thereby reducing the inner diameter of the clamping ring. Conversely, when the cam lever is switched from the locked position to the unlocked position, the first pivot mount and the second pivot mount move apart, thereby increasing the inner diameter of the clamping ring.

In a preferred embodiment, the first pivot mount and the second pivot mount are each formed with a relief gap that provides movement clearance for the linkage rod.

In another preferred embodiment, the second pivot pin is positioned on the outer side of the first pivot mount, such that the second pivot pin moves externally to the first pivot mount under the actuation of the cam lever, thereby reducing interference.

In another preferred embodiment, the cam lever is formed with a pivot recess, into which the first pivot mount extends. The first pivot comprises a first pivot shaft and a second pivot shaft. The first pivot shaft extends from one side of the cam lever, passing through the cam lever and into the first pivot mount, while the second pivot shaft extends from the opposite side of the cam lever, similarly passing through the cam lever and into the first pivot mount.

A telescopic leg comprises an inner tube, an outer tube, and the aforementioned locking assembly. A plurality of first clamping segments is arranged at an end of the outer tube, and the clamping ring is sleeved around the outer surface of the first clamping segments. The inner tube is axially movable within the outer tube. When the cam lever is switched from the unlocked position to the locked position, the inner diameter of the clamping ring is reduced, causing the clamping ring to compress the first clamping segments against the outer surface of the inner tube, thereby restricting axial displacement between the inner and outer tubes. When the cam lever is switched from the locked position to the unlocked position, the inner diameter of the clamping ring increases, allowing the first clamping segments to disengage from the inner tube and permitting relative axial movement between the tubes.

In a preferred embodiment, an alignment sleeve is disposed between the first clamping segments and the inner tube. The alignment sleeve includes a plurality of second clamping segments abutting the first clamping segments, and at least one of the second clamping segments is connected to the first clamping segments and the clamping ring via a positioning mechanism.

In another preferred embodiment, the alignment sleeve is formed with a retaining ring that abuts an end of the first clamping segments. The clamping ring includes a retention slot, into which the retaining ring disposes, thereby preventing axial dislocation of the clamping ring.

A photographic tripod comprises a tripod base, a center column, and a plurality of the telescopic legs described above. The tripod base is formed with a vertically extending guide slot. The center column is disposed through the guide slot and is formed with a plurality of inwardly recessed storage recesses. One end of each telescopic leg is hingedly connected to the tripod base. Each telescopic leg is configured to rotate outward from the tripod base to an extended position or to rotate inward toward the tripod base to be received within the corresponding storage recess.

In a preferred embodiment, the center column is formed with a plurality of lightening holes to improve portability by lowering overall tripod weight.

In another preferred embodiment, the center column includes a tool compartment configured to receive a screwdriver or wrench, thereby enhancing field usability and tool accessibility.

### Advantages of the Invention

The locking assembly, the telescopic leg incorporating the structure, and the photographic tripod as a whole utilize a mechanical system comprising the clamping ring, cam lever, linkage rod, first pivot pin, second pivot pin, and third pivot pin. The clamping ring includes a locking channel with the first pivot mount and second pivot mount respectively disposed on opposite sides. The cam lever is pivotally connected to the first pivot mount and transitions between a locked and an unlocked position. One end of the linkage rod is connected to the cam lever via the second pivot pin, and an opposite end of the linkage rod is connected to the second pivot mount via the third pivot pin. Through its linkage to the linkage rod, the cam lever drives the pivot mounts toward or away from one another, thereby adjusting the inner diameter of the clamping ring. This structure offers ease of operation, reduces mechanical wear, and ensures stable and effective locking performance under repeated use, thereby meeting the practical demands of users.

### BRIEF DESCRIPTION OF THE DRAWINGS

The foregoing and/or additional aspects and advantages of the present invention will become apparent and readily understood from the following description of the embodiments with reference to the accompanying drawings, in which:

FIG. 1 is a schematic view showing the photographic tripod in a first (folded) state;

FIG. 2 is a schematic view showing the photographic tripod in a second (extended) state;

FIG. 3 is an exploded view of the center column;

FIG. 4 is a schematic view showing the telescopic leg in a first (unlocked) state;

FIG. 5 is a schematic view showing the telescopic leg in a second (locked) state; and

FIG. 6 is an exploded view of the telescopic leg.

### DETAILED DESCRIPTION OF THE PREFERRED EMBODIMENTS

This section provides a detailed description of specific embodiments of the present invention. Preferred embodiments are illustrated in the accompanying drawings, which visually supplement the textual disclosure to facilitate intuitive and comprehensive understanding of the technical features and the overall technical solution. However, these drawings are provided for illustrative purposes only and should not be construed as limiting the scope of the invention.

As used herein, the term “a plurality” refers to two or more. Terms such as “greater than,” “less than,” or “exceeding” are to be interpreted as exclusive of the stated number, whereas terms such as “at least,” “no more than,” “not greater than,” and “within” are inclusive. The use of ordinal terms such as “first” and “second” is intended solely to distinguish technical features and does not imply any priority, quantity, or sequence unless expressly stated otherwise.

Directional terms such as “upper,” “lower,” “front,” “rear,” “left,” and “right” refer to orientations or positional relationships based on those shown in the drawings. These directional references are used for descriptive clarity and convenience and do not indicate that the components must be arranged, constructed, or operated in a specific spatial orientation. Accordingly, such terminology should not be construed as limiting the invention.

Unless otherwise specified, terms such as “disposed,” “installed,” or “connected” are to be interpreted broadly. These terms encompass direct and indirect connections, fixed or detachable connections, integral formations, mechanical linkages, internal communication between components, or interactive engagement. One of ordinary skill in the art can determine the most appropriate interpretation in view of the particular structure or implementation of the invention.

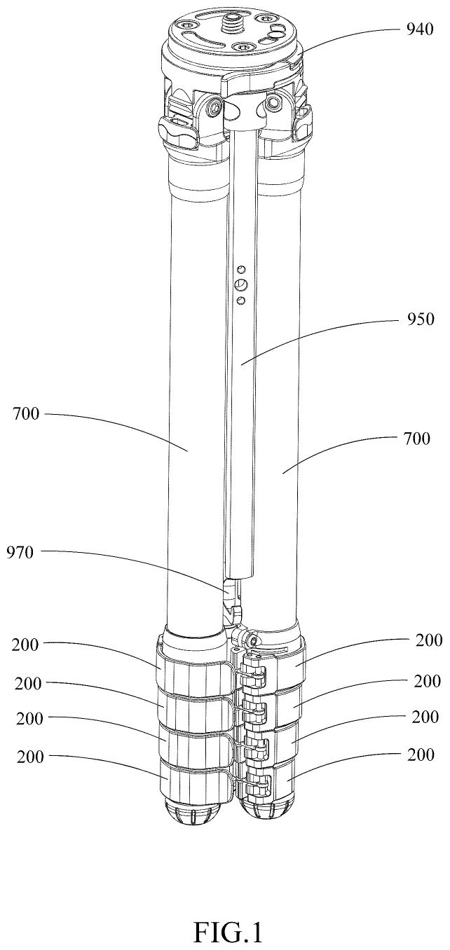

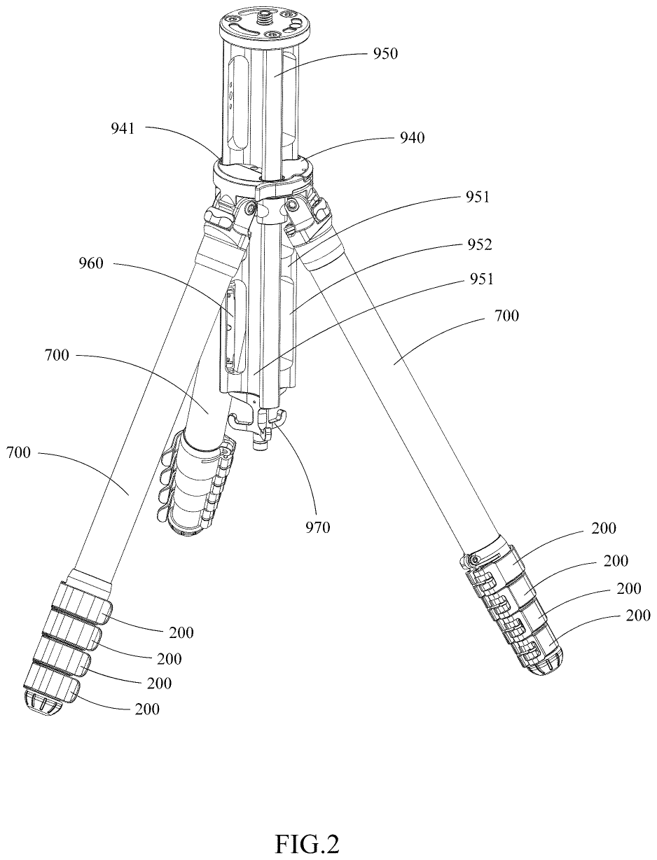

Referring to FIGS. 1, 2, and 4 through 6, the locking assembly comprises a clamping ring 100, a cam lever 200, a linkage rod 300, a first pivot pin 410, a second pivot pin 420, and a third pivot pin 430. The clamping ring 100 is formed with a locking channel 110. A first pivot mount 120 is disposed on one side of the locking channel 110, and a second pivot mount 130 is disposed on the opposite side. One end of the cam lever 200 is pivotally connected to the first pivot mount 120 via the first pivot pin 410. The cam lever 200 is operable to switch between an unlocked position and a locked position. One end of the linkage rod 300 is connected to the cam lever 200 via the second pivot pin 420, and the other end of the linkage rod 300 is connected to the second pivot mount 130 via the third pivot pin 430. When the cam lever 200 transitions from the unlocked position to the locked position, it drives the first pivot mount 120 and the second pivot mount 130 to move toward one another via the linkage rod 300, thereby reducing the inner diameter of the clamping ring 100. Conversely, when the cam lever 200 is switched from the locked position to the unlocked position, the first pivot mount 120 and the second pivot mount 130 move apart, increasing the inner diameter of the clamping ring 100.

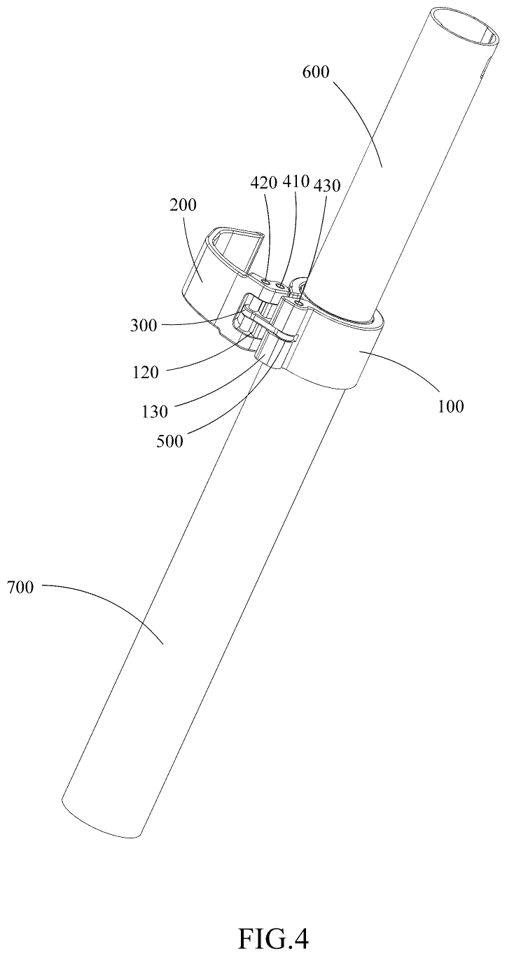

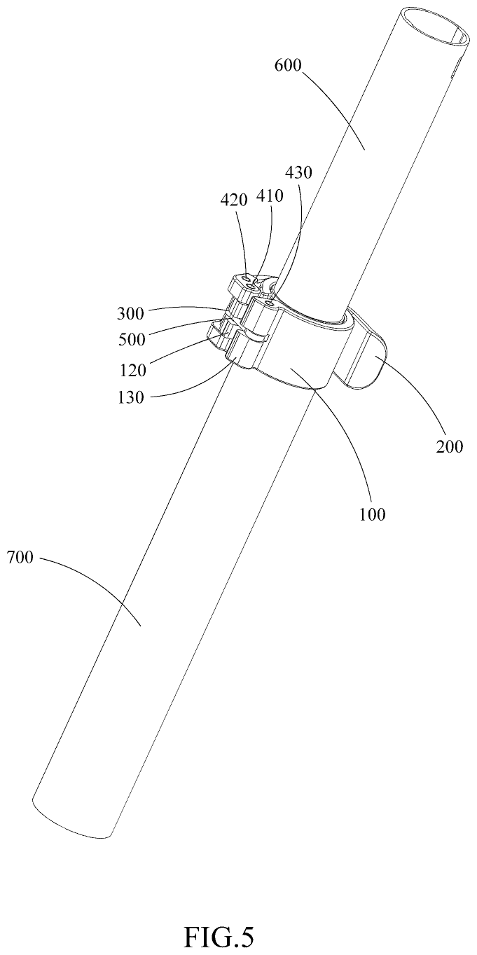

Referring to FIG. 4, the structure of the locking mechanism in its unlocked state is illustrated. FIG. 5 shows the locking assembly in its locked state. As further illustrated in FIGS. 4 through 6, the telescopic leg includes an inner tube 600, an outer tube 700, and the locking assembly described above. An end of the outer tube 700 is formed with a plurality of first clamping segments 710. The clamping ring 100 is sleeved around the outer surface of the first clamping segments 710, and the inner tube 600 is axially movably disposed within the outer tube 700. When the cam lever 200 transitions from the unlocked position to the locked position, it reduces the inner diameter of the clamping ring 100, causing the clamping ring 100 to compress the first clamping segments 710 against the outer surface of the inner tube 600. This engagement restricts axial displacement between the inner tube 600 and the outer tube 700. Conversely, when the cam lever 200 transitions from the locked position to the unlocked position, the inner diameter of the clamping ring 100 increases, releasing the first clamping segments 710 from the inner tube 600, thereby allowing relative axial movement between the inner tube 600 and the outer tube 700.

To illustrate the operation, consider the process by which the telescopic leg transitions from the unlocked state shown in FIG. 4 to the locked state shown in FIG. 5. In the unlocked state, the cam lever 200 rotates inward relative to the inner tube 600 and the outer tube 700 about the axis of the first pivot pin 410. This rotation causes the linkage rod 300 to move toward the first pivot mount 120, thereby driving the second pivot mount 130 toward the first pivot mount 120. As a result, the distance between the two pivot mounts is reduced, which narrows the width of the locking channel 110 and ultimately reduces the inner diameter of the clamping ring 100. When the cam lever 200 is rotated into a position close to or in contact with the outer tube 700, the clamping ring 100 reaches its minimum inner diameter, thereby maximizing its locking force. As the clamping ring 100 contracts, it compresses the first clamping segments 710 until they abut the outer surface of the inner tube 600. The resulting frictional force between the first clamping segments 710 and the inner tube 600 restricts axial movement between the inner and outer tubes, thereby locking the telescopic leg in position. The unlocking process proceeds in reverse and is omitted here for brevity, though it is fully within the scope of the invention. Notably, multiple inner tubes 600, outer tubes 700, and associated locking assembles may be arranged in series to form a telescopic leg with a multi-stage extension structure, thereby enabling the leg to extend or retract as needed.

Referring to FIGS. 4 through 6, in some embodiments, the first pivot mount 120 and the second pivot mount 130 are each formed with relief gaps 500 that are configured to provide motion clearance for the linkage rod 300. As the linkage rod 300 moves toward the first pivot mount 120 and inwardly toward the center of the outer tube 700, these relief gaps 500 help prevent mechanical interference with the linkage rod's movement.

Referring again to FIGS. 4 through 6, in some embodiments, the second pivot pin 420 is positioned on the outer side of the first pivot mount 120 such that, when driven by the cam lever 200, the second pivot pin 420 moves along a trajectory outside the outer profile of the first pivot mount 120. This configuration effectively prevents kinematic interference between the second pivot pin 420 and the first pivot mount 120 during operation.

As shown in FIGS. 4 through 6, in some embodiments, the cam lever 200 includes a pivot recess 210 into which the first pivot mount 120 extends. The first pivot pin 410 includes a first pivot shaft 411 and a second pivot shaft 412. During assembly, the first pivot mount 120 is installed into the pivot recess 210 of the cam lever 200. The first pivot shaft 411 is inserted from one side of the cam lever 200 and extends through both the cam lever 200 and the first pivot mount 120. Similarly, the second pivot shaft 412 is inserted from the opposite side of the cam lever 200 and also extends through both the cam lever 200 and the first pivot mount 120, thereby providing bilateral rotational support for the cam lever 200. One end of the linkage rod 300 is also installed into the pivot recess 210, while the opposite end is installed into the relief gap 500 of the second pivot mount 130. The second pivot pin 420 is then inserted through the first end of the linkage rod 300 and into the cam lever 200, while the third pivot pin 430 is inserted through the second end of the linkage rod 300 and into the second pivot mount 130.

Referring to FIGS. 4 through 6, in some embodiments, an alignment sleeve 800 is interposed between the first clamping segments 710 and the inner tube 600. The alignment sleeve 800 includes a plurality of second clamping segments 810 that abut the first clamping segments 710. At least one of the second clamping segments 810 is connected to the first clamping segments 710 and to the clamping ring 100 via a positioning mechanism 900. In a preferred embodiment, the positioning mechanism 900 includes a positioning protrusion 910 formed on the second clamping segment 810, a first alignment hole 920 formed in the first clamping segment 710, and a second alignment hole 930 formed in the clamping ring 100. The positioning protrusion 910 is configured to extend through both the first alignment hole 920 and the second alignment hole 930. During assembly, the clamping ring 100 is sleeved around the outer side of the first clamping segments 710 such that the second alignment hole 930 is aligned with the first alignment hole 920 on the outer tube 700. The alignment sleeve 800 is then inserted into the outer tube 700 so that the positioning protrusion 910 extends into both alignment holes 920 and 930. This establishes positional alignment among the alignment sleeve 800, the outer tube 700, and the clamping ring 100. Subsequently, the inner tube 600 is inserted into the alignment sleeve 800. When the inner diameter of the clamping ring 100 is reduced, the deformation of the first clamping segments 710 in turn causes the second clamping segments 810 to deform and press against the outer wall of the inner tube 600. Friction between the second clamping segments 810 and the inner tube 600 restricts axial movement between the inner tube 600 and the outer tube 700, thereby achieving a secure locking state for the telescopic leg.

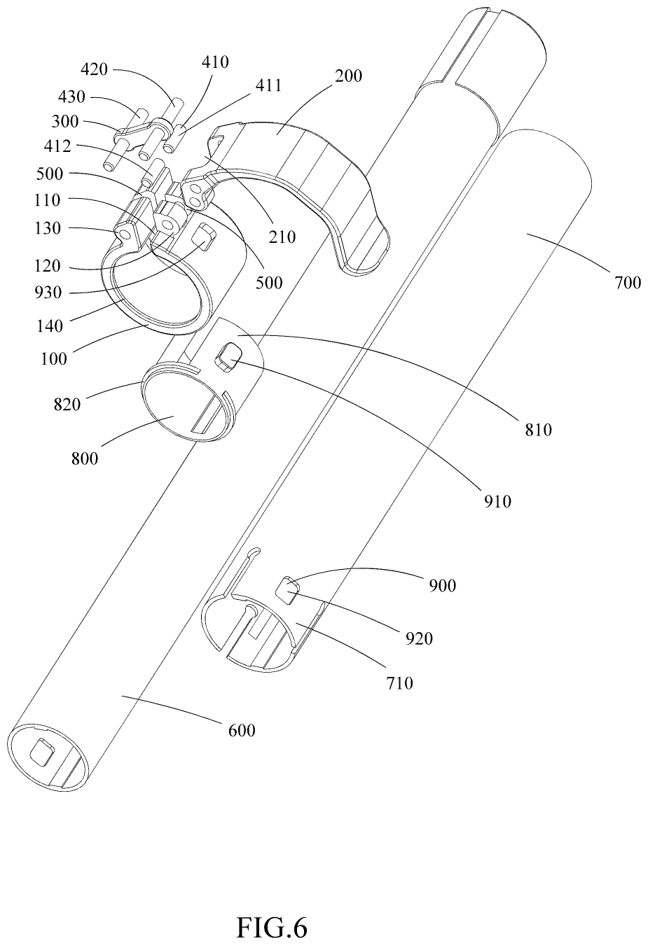

Referring to FIG. 6, in some embodiments, the second alignment hole 930 is located proximate to the first pivot mount 120. This configuration allows the portion of the clamping ring 100 adjacent to the first pivot mount 120 to remain substantially stationary, while the opposite side adjacent to the second pivot mount 130 is movable toward or away from the first pivot mount 120. This asymmetric displacement enables dynamic adjustment of the inner diameter of the clamping ring 100 with reduced structural distortion.

Referring again to FIG. 6, in some embodiments, the alignment sleeve 800 is provided with a retaining ring 820 that abuts an end of the first clamping segments 710. The clamping ring 100 is formed with a retention slot 140 into which the retaining ring 820 disposes. This configuration serves to restrict axial displacement of the clamping ring 100, thereby preventing detachment from the outer tube 700 and further enhancing the structural stability of the locking assembly.

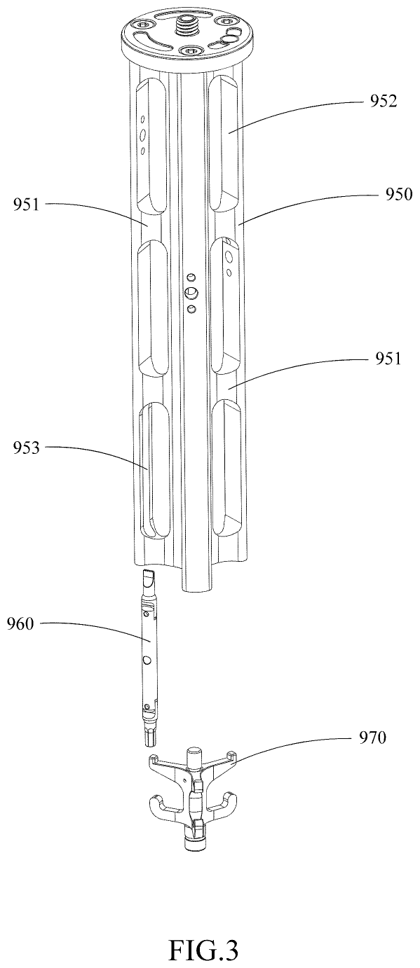

Referring to FIGS. 1 through 3, the invention further provides a photographic tripod comprising a tripod base 940, a center column 950, and a plurality of telescopic legs as previously described. The tripod base 940 is formed with a vertically extending guide slot 941. The center column 950 extends through the guide slot 941 and includes a plurality of inwardly recessed storage recesses 951. One end of each telescopic leg is pivotally connected to the tripod base 940. Each telescopic leg is rotatable outward from the tripod base 940 to transition to an extended position, or rotatable inward toward the tripod base 940 to be housed within a corresponding storage recess 951. Specifically, when the photographic tripod is not in use, the telescopic legs are rotated inward such that they are received within the corresponding storage recesses 951 formed in the center column 950. In some embodiments, the tripod is configured with three telescopic legs, and the center column 950 is formed with three equally spaced storage recesses 951 disposed circumferentially around its outer surface. Each telescopic leg is accommodated within a respective storage recess 951. When the tripod is to be deployed, the telescopic legs are rotated outward from the storage recesses 951 into their extended positions to provide structural support. Photographic equipment is mounted on a head assembly that is secured to the center column 950. A locking assembly is provided between the center column 950 and the tripod base 940 to maintain their relative position, thereby allowing adjustment of the vertical height of the photographic equipment in order to accommodate different shooting requirements.

Referring again to FIGS. 1 through 3, in some embodiments, the center column 950 includes a plurality of lightening holes 952. These apertures serve to reduce the overall weight of the center column 950, thereby enhancing the portability of the photographic tripod without compromising its structural integrity.

As further shown in FIGS. 1 through 3, in some embodiments, the center column 950 is formed with a tool compartment 953 that houses a screwdriver 960 or a wrench. The tool compartment 953 may be located on a sidewall of the center column 950 or integrated into a sidewall of one of the lightening holes 952. The screwdriver 960 or wrench may be secured within the tool compartment 953 by means of a magnetic element or by structural retention. In one example, the tool compartment 953 is configured to communicate with the bottom end of the center column 950, and a retaining hook 970 located at the bottom of the center column 950 is used to retain the screwdriver 960 or wrench in place.

The invention thus provides a locking assembly, a telescopic leg, and a photographic tripod that collectively offer operational simplicity, reduced mechanical wear, and reliable locking performance, fully satisfying practical usage requirements.

It is to be understood that the foregoing embodiments are presented by way of illustration only and not limitation. Various substitutions, modifications, and equivalent configurations may be made by those skilled in the art without departing from the spirit and scope of the invention. Such equivalents are intended to fall within the scope of the claims appended hereto.

What is claimed is:

1. A locking assembly comprising:
a clamping ring, a cam lever, a linkage rod, a first pivot pin, a second pivot pin, and a third pivot pin,
wherein the clamping ring comprises a locking channel having a first pivot mount on one side and a second pivot mount on an opposite side;
wherein one end of the cam lever is connected to the first pivot mount via the first pivot pin and is switchable between an unlocked position and a locked position;
wherein one end of the linkage rod is connected to the cam lever via the second pivot pin, and an opposite end of the linkage rod is connected to the second pivot mount via the third pivot pin; and
wherein the cam lever drives, via the linkage rod, the first pivot mount and the second pivot mount to move toward each other when switching from the unlocked position to the locked position, thereby reducing an inner diameter of the clamping ring, or the first pivot mount and the second pivot mount move apart when the cam lever switches from the locked position to the unlocked position, thereby increasing the inner diameter of the clamping ring.

2. The locking assembly of claim 1, wherein the first pivot mount and the second pivot mount respectively include relief gaps configured to provide clearance for the linkage rod to move.

3. The locking assembly of claim 1, wherein the second pivot pin is positioned on the outer side of the first pivot mount such that the second pivot pin moves externally to the first pivot mount when driven by the cam lever.

4. The locking assembly of claim 1, wherein the cam lever includes a pivot recess, the first pivot mount extends into the pivot recess, the first pivot pin comprises a first pivot shaft and a second pivot shaft, the first pivot shaft inserts from one side of the cam lever through both the cam lever and the first pivot mount, and the second pivot shaft inserts from an opposite side of the cam lever through both the cam lever and the first pivot mount.

5. A telescopic leg comprising:
an inner tube, an outer tube, and the locking assembly of claim 1,
wherein an end of the outer tube comprises a plurality of first clamping segments,
wherein the clamping ring is sleeved around an outer surface of the first clamping segments,
wherein the inner tube is axially movably disposed within the outer tube, and
wherein the cam lever reduces the inner diameter of the clamping ring when switching from the unlocked position to the locked position, causing the clamping ring to press the first clamping segments against the inner tube to restrict axial movement between the inner tube and the outer tube, or increases the inner diameter of the clamping ring when switching from the locked position to the unlocked position, allowing the first clamping segments to disengage from the inner tube and permitting axial movement of the inner tube relative to the outer tube.

6. The telescopic leg of claim 5, wherein an alignment sleeve is disposed between the first clamping segments and the inner tube,
wherein the alignment sleeve comprises a plurality of second clamping segments abutting the first clamping segments, and
wherein at least one of the second clamping segments is connected to the first clamping segments and the clamping ring via a positioning mechanism.

7. The telescopic leg of claim 6, wherein the alignment sleeve includes a retaining ring abutting an end of the first clamping segments,
wherein the clamping ring comprises a retention slot, and
wherein the retaining ring disposes into the retention slot.

8. A photographic tripod comprising:
a tripod base, a center column, and the telescopic leg of claim 5,
wherein the tripod base comprises a vertically extending guide slot,
wherein the center column extends through the guide slot and comprises a plurality of inwardly recessed storage recesses,
wherein one end of each telescopic leg is hingedly connected to the tripod base, and
wherein each telescopic leg is rotatable outward relative to the tripod base to an extended position or rotatable inward relative to the tripod base to be received in the storage recesses.

9. The photographic tripod of claim 8, wherein the center column comprises a plurality of lightening holes.

10. The photographic tripod of claim 8, wherein the center column comprises a tool compartment containing a screwdriver or a wrench.
